(19) United States
(12) Patent Application Publication
(10) Pub. No.: US 2008/0053537 A1
(43) Pub. Date: Mar. 6, 2008

(54) Check valve assembly including position indicator and method of operation

(75) Inventors: G. Stephen McGonigle, Gilbert, AZ (US); Joseph J. Jira, Laveen, AZ (US); Jeremiah J. Warriner, Chandler, AZ (US); Stuart K. Denike, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/515,118

(22) Filed: Aug. 31, 2006

(51) Int. Cl. F16K 37/00; F16K 15/03

(52) U.S. Cl. 137/512.1; 137/554

(57) ABSTRACT

A check valve assembly including a position indicator and method of operation, wherein the position indicator indicates the position of at least one of a plurality of flappers. The valve assembly including at least one bridge conductor and at least one pair of spaced apart mating conductors formed on at least one of a fluid flow opening and/or on a flapper stop. During operation, the bridge conductor bridges the pairs of conductors formed about at least one fluid flow opening thereby generating a signal to alert a controller that the flapper is in a closed position. Alternatively, or in addition to, the bridge conductor bridges the pair of conductors on the flapper stop thereby generating a signal to alert a controller that the flapper is in a full-open position.

### TECHNICAL FIELD

The present invention relates to a check valve, and more particularly relates to a check valve including a position indicator that indicates when the valve is in an open or a closed position.

### BACKGROUND

Non-return valves or check valves have long been known for allowing fluid flow in only one direction. Any reversal of the flow in the undesired direction results in stoppage or checking of the flow. This invention relates to a specific body construction and assembly for a check valve for carrying a fluid flow.

In many applications, it is desirable to provide a check valve at one or more spaced locations in a pipe line or conduit for handling fluid flows. The check valve assures against back flow and provides a safety margin in the unlikely event of line breakage. These types of check valves are commonly referred to as insert check valves and allow for insertion of the check valve within confined space, such as a pipe, or the like. One inherent challenge that presents when the check valve is inaccessible is the ability to monitor the operation to ensure proper flow is achieved through the check valve. Typical prior art check valve assemblies are comprised of a flow section, a plurality of flappers, a stop tube for controlling the angle of opening of the flappers, and a plurality of vertical supports, commonly referred to as ears, for supporting the stop tube in its proper position.

During operation to ensure that proper flow is achieved through the check valve, it is beneficial to know what position the flappers are in relative to the flow section and the stop valve assembly, (i.e. closed or open) and to what extent. In the past, flow sensors may have been utilized in many instances to ensure that a fluid flow is present in a line when it is supposed to be present, and a valve is supposed to be open, and is not present, when a valve is supposed to be closed. These types of flow sensors send a signal indicating whether there is flow or no flow and in certain cases the quantity of the fluid flow. A controller compares the signal to an expected outcome and either allows the system to continue functioning or commands an evasive action or alarm to occur if the actual outcome is different than an expected outcome.

In other instances, a valve signal indicator mechanism may be utilized and relies on movement of hydraulic fluid or upon mechanically or hydraulically energized position indicator mechanisms to alert a controller as to the position of the valve. These types of flow sensors and valve signal indicator mechanisms have had certain historical disadvantages due to their fragility and difficulty in being manufactured, poor sensitivity to fluid flow changes, and slow response time.

Hence, there is a need for an improved means of determining the status of a check valve during operation, and more particularly the position of the check valve flappers in relation to the check valve flow body and stop assembly whereby status of the valve can be determined when the valve is inaccessible.

### BRIEF SUMMARY

The present invention provides a check valve assembly comprising a valve body, a flapper, a first and second conductor, and a bridge conductor. The valve body includes a flow opening. The flapper is rotationally mounted on the valve body and moveable between a closed position, in which the flapper at least substantially seals the flow channel, and a full-open position, in which the flapper unseals the flow channel. The first and second conductor are coupled to the valve body and spaced apart from each other to form an open circuit. The first and second conductors are each adapted to be electrically coupled to an electrical power source. The bridge conductor is coupled to the flapper and configured to selectively close the open circuit formed by the first and second conductors when the flapper is in one of the closed or full-open positions.

The present invention further provides a check valve assembly comprising a valve body, a plurality of stop supports, a flapper, a flapper stop, first and second conductors and a bridge conductor. The valve body includes a flow opening. The plurality of stop supports are coupled to, and extend axially from, the valve body. The flapper includes an upstream side and a downstream side. The flapper is rotationally mounted on the valve body and moveable between a closed position, in which the flapper at least substantially seals the flow channel, and a full-open position, in which the flapper unseals the flow channel. The flapper stop is coupled between the stop supports and configured to engage the flapper, and thereby limit flapper rotation. In the full-open position, the downstream side of the flapper engages the flapper stop when the flapper is in the full-open position. The first and second conductors-are coupled to the flapper stop and spaced apart from each other to form an open circuit. The first and second conductors are each adapted to be electrically coupled to an electrical power source. The bridge conductor is coupled to the flapper downstream side and configured to selectively close the open circuit formed by the first and second conductors when the flapper is in the full-open position.

The present invention further provides a check valve assembly comprising a valve body including a flow opening, a flapper, first and second conductors coupled to the valve body adjacent the flow opening, and a bridge conductor. The flapper includes an upstream side and a downstream side. The flapper is rotationally mounted on the valve body and moveable between a closed position, in which the flapper at least substantially seals the flow channel, and a full-open position, in which the flapper unseals the flow channel, wherein the upstream side engages the valve body at least adjacent the flow opening when the flapper is in the closed position. The first and second conductors are coupled to the valve body adjacent the flow opening and spaced apart from each other to form an open circuit. The first and second conductors are each adapted to be electrically coupled to an electrical power source. The bridge conductor is coupled to the flapper upstream side and configured to selectively close the open circuit formed by the first and second conductors when the flapper is in the closed position.

The present invention further provides a check valve assembly comprising a valve body having a flow opening, a plurality of stop supports, a flapper, a flapper stop, first and second conductors coupled to the flapper stop, first and second conductors coupled to the valve body adjacent the flow opening, a first bridge conductor and a second bridge conductor. The plurality of stop supports are coupled to, and extend axially from, the valve body. The flapper, including an upstream side and a downstream side, is rotationally mounted on the valve body and moveable between a closed position, in which the flapper at least substantially seals the flow channel, and a full-open position, in which the flapper unseals the flow channel. The flapper stop is coupled between the stop supports and configured to engage the flapper, and thereby limit flapper rotation, in the full-open position. The downstream side of the flapper engages the flapper stop when the flapper is in the full-open position and the upstream side of the flapper engages the valve body at least adjacent the flow opening when the flapper is in the closed position. The first and second conductors are coupled to the flapper stop and spaced apart from each other to form an open circuit. The first and second conductors are each adapted to be electrically coupled to an electrical power source. The first and second conductors are coupled to the valve body adjacent the flow opening and spaced apart from each other to form an open circuit. The first and second conductors are each adapted to be electrically coupled to an electrical power source. The first bridge conductor is coupled to the flapper downstream side and configured to selectively close the open circuit formed by the first and second conductors coupled to the flapper stop when the flapper is the full-open position. The second bridge conductor is coupled to the flapper upstream side and configured to selectively close the open circuit formed by the first and second conductors coupled to the valve body adjacent the flow opening when the flapper is the closed position.

The present invention also provides a method of indicating the position of a check valve assembly comprising the steps of providing a valve body having a flow opening, rotationally mounting a flapper on the valve body, coupling first and second conductors to the valve body, coupling a bridge conductor to the flapper, and monitoring the circuit to determine if at least one of the plurality of flappers is in an open or a closed position. The flapper is moveable between a closed position, in which the flapper at least substantially seals the flow channel, and a full-open position, in which the flapper unseals the flow channel. The first and second conductors coupled to the valve body are spaced apart from each other to form an open circuit and each adapted to be electrically coupled to an electrical power source. The bridge conductor is configured to selectively close the open circuit formed by the first and second conductors when the flapper is in one of the closed or full-open positions.

Other independent features and advantages of the preferred apparatus and method will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a check valve assembly including a position indicator according to an embodiment of the invention;

FIG. 2 is a top view of a portion of a check valve flow body including a portion of a position indicator according to an embodiment of the invention;

FIG. 3 is a plan view of a second side of a check valve flapper including a portion of a position indicator according to an embodiment of the invention;

FIG. 4 is a side view of a portion of a check valve flow body including a portion of a position indicator according to an embodiment of the invention; and

FIG. 5 is a plan view of a first side of a check valve flapper including a portion of a position indicator according to an embodiment of the invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

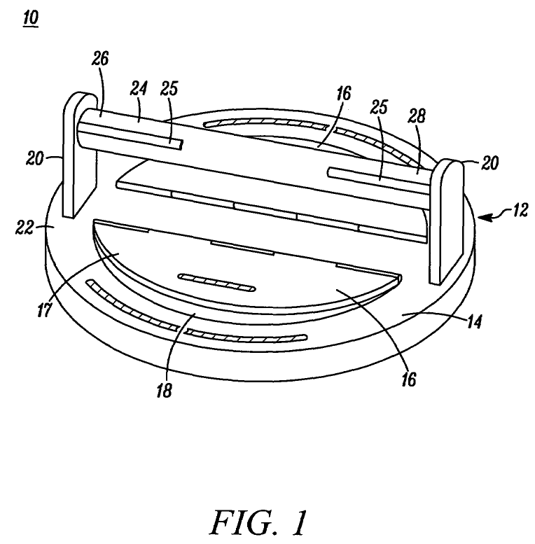

FIG. 1 is a perspective view of a check valve assembly 10 according to the present invention. Check valve assembly 10 is generally comprised of a valve body 12, including a flow section 14 onto which a plurality of flappers 16 are rotationally mounted (of which only one is illustrated in a partially open position). The flappers 16 are generally formed of a non-conductive material having a first side 17 and an opposed second side (not shown). The flappers 16 control the passage of a fluid through a plurality of openings 18 formed in the check valve flow section 14. It should be understood that the position indicator of the present invention could be implemented with a single flapper and opening.

A plurality of vertical stop supports 20 extend axially from, and at least substantially perpendicular to, a surface 22 of the flow section 14. The vertical stop supports 20 provide positioning and retention of a flapper stop 24, and more particularly a first end 26 and a second end 28 of the flapper stop 24. The dimensions of the flapper stop 24 controls the angle of the flappers 16 when moved to a full-open position during operation.

During operation a plurality of mating conductors (described presently) are embedded, positioned on, or otherwise coupled to the flappers 16, the check valve flow section 14, and/or the flapper stop 24 to form a check valve position indicator system 25. The check valve position indicator system 25 operates by forming a closed circuit when the flappers 16 are in one of the closed or full-open positions, resulting in notification to a check valve controller (not shown) of the status of the check valve assembly 10.

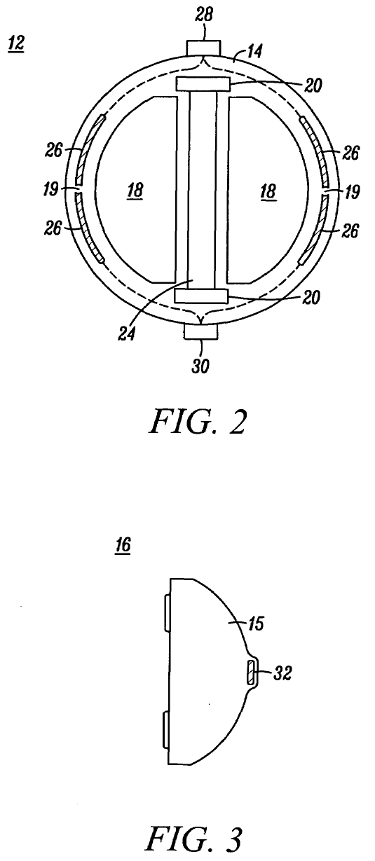

Referring now to FIG.2, illustrated in plan view is a portion of valve body 12, and more specifically a check valve flow section 14 having the plurality of openings 18 formed there through. In addition, illustrated are the plurality of vertical stop supports 20 that support the flapper stop 24. Flow section 14 is generally comprised of a non-conductive material, such as a polymer or composite, an example being Ultem® PolyEtherImide, though it could be constructed of any one of numerous conductive or partially conductive materials. In this particular embodiment, a plurality of conductors 26 are embedded in the surface 22 of flow section 14. The conductors 26 are generally formed of a typical conductive materials, such as aluminum or copper. Flow body 12 further includes an input port 28 and an output port 30, each of which is adapted to be electrically coupled to an electrical power source. As illustrated in FIG. 2, two of the conductors 26 are in electrical communication with the input port 28, and two of the conductors are in electrical communication with the output port 30, and are generally positioned adjacent the flow openings 18. The conductors 26 associated with each flow opening 18 are spaced apart from each other to form an open circuit when the check valve assembly 10, and more particularly the flappers 16, are in an open position (described further below).

Referring now to FIG. 3, illustrated in plan view is a second, or upstream side 15 of a single flapper 16. When assembled together with the check valve flow section 14 of FIG. 2, the upstream side 15 of the flapper 16 rests against a portion of the flow section 14 when the flappers 16 are in the closed position. It should be understood that although a single flapper 16 is shown and described, the check valve assembly 10 would preferably include dual flappers 16 formed in generally the same manner. The flapper 16 in this particular embodiment is formed of a non-conductive material, such as a polymer or composite, an example being Ultem® PolyEtherImide, having embedded into the surface of the second side 15 a bridge conductor 32. The bridge conductor 32 is formed of a typical conductive material, such as aluminum or copper. The bridge conductor 32 is positioned to align with the conductors 26, and close the open circuit, when the flapper 16 is in the closed position.

During operation of check valve assembly 10, when the bridge conductor 32 of flapper, or flappers, 16 comes in contact with the conductors 26 of the flow body 12, the open circuit formed there between is closed. Thus, when the input and output ports 28 and 30 are electrically coupled to an electrical power source, a current will flow. This current flow can be used to energize an indicator (not shown) that indicates the flappers 16 are in the closed position. While the conductors 26 are shown symmetrically formed about the flow body 12, it should be understood that they are capable of operation separately to provide notification of a single closed flapper 16 or of the dual flappers 16.

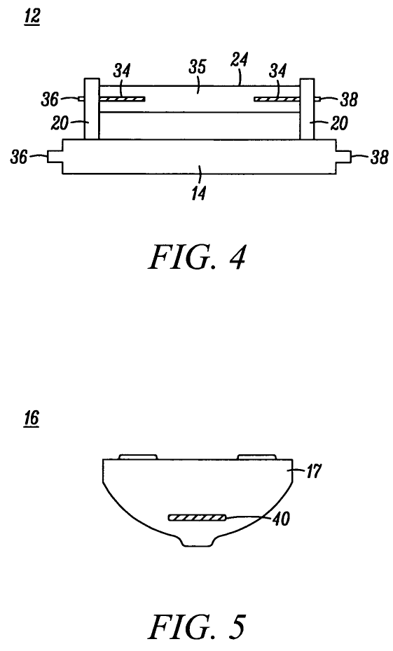

Referring now to FIG. 4, illustrated in a side view is a portion of the valve body 12, and more specifically illustrating the check valve flow section 14, the substantially vertical stop supports 20 and the flapper stop 24. The substantially vertical stop supports 20 and the flapper stop 24 are generally comprised of a non-conductive material, such as a polymer or composite, an example being Ultem® PolyEtherImide, though they could also be constructed of any of numerous conductive or partially conductive materials. In this particular embodiment, a plurality of conductors 34 are positioned on a surface of flapper stop 24 or embedded in a portion of the flapper stop 24. The conductors 34 are generally formed of a typical conductive material, such as aluminum or copper. Flow body 12 further includes an input port 36 and an output port 38, generally similar to the input port 28 and the output port 30 of the first embodiment. The input port 36 and the output port 38 are each adapted to be electrically coupled to an electrical power source. As illustrated in FIG. 4, two conductors 34 are shown generally positioned on a side aspect of the stop valve flow assembly 24. One of the conductors 34 is in electrical communication with the input port 36, and one of the conductors 34 is in electrical communication with the output port 38. In the preferred embodiment, a similar pair of conductors (not shown) are formed on an opposed side aspect of the flapper stop 24 and in similar electrical communication with the input port 36 and output port 38 to provide indication of the position of the dual flappers 16. The conductors 34 associated on each side of the flapper stop 24 are spaced apart from each other to form an open circuit when the check valve assembly 10, and more particularly the flappers 16, are in a closed position (described further below).

Referring now to FIG. 5, illustrated in plan view is the first, or downstream side 17 of a single flapper 16. It should again be understood that although a single flapper 16 is shown and described, the check valve assembly 10 would preferably include dual flappers 16 formed in generally the same manner. The flapper 16 in this particular embodiment has embedded into the surface of the downstream side 17 a bridge conductor 40 formed of a typical conductive material, such as aluminum or copper. The bridge conductor 40 is positioned to align with the conductors 34, and thus close the open circuit when the flapper 16, or flappers are in the open position.

During operation of check valve assembly 10, when the bridge conductor 40 of flapper 16, or flappers, comes in contact with the conductors 34 of the flapper stop 24 the open circuit formed there between is closed. Thus, when the input and output ports 36 and 38 are electrically coupled to an electrical power source, a current will flow. This current flow can be used to energize an indicator that indicates the flappers 16 are in the open position, thereby allowing fluid flow through the openings 18 (FIG. 1) of the valve body 12. It should be understood that the position indicator system is capable of operating to provide notification of a single open flapper 16 or of the dual flappers 16.

In contrast to prior indicator systems, in the embodiments disclosed, the position indicator system 25 does not rely on the measurement of a fluid flow through the check valve assembly 10. In addition, the check valve assembly 10 may be formed to include the position indicator system 25 according to the first embodiment, which allows monitoring of the flappers 16 to indicate a closed position, or it may be formed to include the position indicator system 25 according to the second embodiment, which allows monitoring of the flappers 16 to indicate an open position. In most check valve assembly 10 configurations according to the present invention, the position indicator system 25 would be implemented to incorporate both embodiments and allow for monitoring of the flappers 16 to indicate both a closed position and an open position.

Thus, the check valve assembly 10 of the present invention includes a position indicator system 25 capable of indicating the position of a single flapper or plurality of flappers 16, thereby notifying a check valve controller of the status of fluid flow through the check valve assembly 10. The position indicator system 25 includes a plurality of conductors positioned on, or embedded within, the flappers 16 and at least one of the flow section 14 and the flapper stop 24 to form an open circuit. During operation, completion, or closing of the circuit results in the generation of an output signal and indication of the status of the check valve assembly10.

While the invention has been described with reference to preferred embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A check valve assembly comprising:
a valve body having a flow opening;
a flapper rotationally mounted on the valve body and moveable between a closed position, in which the flapper at least substantially seals the flow channel, and a full-open position, in which the flapper unseals the flow channel;
first and second conductors coupled to the valve body and spaced apart from each other to form an open circuit, the first and second conductors each adapted to be electrically coupled to an electrical power source; and
a bridge conductor coupled to the flapper and configured to selectively close the open circuit formed by the first and second conductors when the flapper is in one of the closed or full-open positions.

2. The check valve assembly of claim 1, wherein the valve body is formed of a non-conductive material.

3. The check valve assembly of claim 1, further comprising:
a plurality of stop supports coupled to, and extending axially from, the valve body; and
a flapper stop coupled between the stop supports and configured to engage the flapper, and thereby limit flapper rotation, in the full-open position,
wherein:
the first and second conductors are coupled to the flapper stop,
the flapper includes an upstream side and a downstream side, the downstream side engaging the flapper stop when the flapper is in the full-open position, and
the bridge conductor is coupled to the flapper downstream side.

4. The check valve assembly of claim 3, wherein the bridge conductor is formed on a surface of the downstream side of the flapper.

5. The check valve assembly of claim 3, wherein the bridge conductor is embedded into a surface of the downstream side of the flapper.

6. The check valve assembly of claim 3, wherein the first and second conductors are formed on a surface of at least one side aspect of the check valve stop.

7. The check valve assembly of claim 3, wherein the first and second conductors are embedded into a surface of at least one side aspect of the check valve stop.

8. The check valve assembly of claim 1, wherein:
the first and second conductors are coupled to the valve body adjacent the flow opening;
the flapper includes an upstream side and a downstream side, the upstream side engaging the valve body at least adjacent the flow opening when the flapper is in the closed position; and
the bridge conductor is coupled to the flapper upstream side.

9. A check valve assembly as claimed in claim 8, wherein the bridge conductor is formed on a surface of the upstream side of the flapper.

10. A check valve assembly as claimed in claim 8, wherein the bridge conductor is embedded into a surface of upstream side of the flapper.

11. A check valve assembly as claimed in claim 8, wherein the first and second conductors are formed on a surface of the valve body.

12. A check valve assembly as claimed in claim 8, wherein the first and second conductors are embedded into a surface of the valve body.

13. The check valve assembly of claim 1, further comprising:
a plurality of stop supports coupled to, and extending axially from, the valve body; and
a flapper stop coupled between the stop supports and configured to engage the flapper, and thereby limit flapper rotation, in the full-open position,
wherein:
a plurality of first and second conductors are coupled to the flapper stop;
a plurality of first and second conductors are coupled to the valve body adjacent the flow opening;
the flapper includes an upstream side and a downstream side, the downstream side engaging the flapper stop when the flapper is in the full-open position and the upstream side engaging the valve body at least adjacent the flow opening when the flapper is in the closed position; and
a first bridge conductor is coupled to the flapper downstream side and a second bridge conductor is coupled to the flapper upstream side.

14. A check valve assembly as claimed in claim 13, wherein the first bridge conductor is formed on one of a surface of the downstream side of the flapper or embedded into a surface of the downstream side of the flapper.

15. A check valve assembly as claimed in claim 13, wherein the plurality of first and second conductors coupled to the flapper stop are one of formed on a surface of at least one side aspect of the check valve stop or embedded in the surface of at least one side aspect of the check valve stop.

16. A check valve assembly as claimed in claim 13, wherein the plurality of first and second conductors coupled to the valve body are one of formed on a surface of the valve body or embedded into a surface of the valve body.

17. A check valve assembly comprising:
a valve body having a flow opening;
a plurality of stop supports coupled to, and extending axially from, the valve body;
a flapper, including an upstream side and a downstream side, rotationally mounted on the valve body and moveable between a closed position, in which the flapper at least substantially seals the flow channel, and a full-open position, in which the flapper unseals the flow channel;
a flapper stop coupled between the stop supports and configured to engage the flapper, and thereby limit flapper rotation, in the full-open position, the downstream side of the flapper engaging the flapper stop when the flapper is in the full-open position;
first and second conductors coupled to the flapper stop and spaced apart from each other to form an open circuit, the first and second conductors each adapted to be electrically coupled to an electrical power source; and
a bridge conductor coupled to the flapper downstream side and configured to selectively close the open circuit formed by the first and second conductors when the flapper is in the full-open position.

18. A check valve assembly comprising:
a valve body having a flow opening;
a flapper, including an upstream side and a downstream side, rotationally mounted on the valve body and moveable between a closed position, in which the flapper at least substantially seals the flow channel, and a full-open position, in which the flapper unseals the flow channel, wherein the upstream side engages the valve body at least adjacent the flow opening when the flapper is in the closed position;
first and second conductors coupled to the valve body adjacent the flow opening and spaced apart from each other to form an open circuit, the first and second conductors each adapted to be electrically coupled to an electrical power source; and
a bridge conductor coupled to the flapper upstream side and configured to selectively close the open circuit formed by the first and second conductors when the flapper is in the closed position.

19. A check valve assembly comprising:
a valve body having a flow opening;
a plurality of stop supports coupled to, and extending axially from, the valve body;
a flapper, including an upstream side and a downstream side, rotationally mounted on the valve body and moveable between a closed position, in which the flapper at least substantially seals the flow channel, and a full-open position, in which the flapper unseals the flow channel;
a flapper stop coupled between the stop supports and configured to engage the flapper, and thereby limit flapper rotation, in the full-open position, the downstream side of the flapper engaging the flapper stop when the flapper is in the full-open position and the upstream side of the flapper engaging the valve body at least adjacent the flow opening when the flapper is in the closed position;
a first and second conductor coupled to the flapper stop and spaced apart from each other to form an open circuit, the first and second conductors each adapted to be electrically coupled to an electrical power source;
a first and second conductor coupled to the valve body adjacent the flow opening and spaced apart from each other to form an open circuit, the first and second conductors each adapted to be electrically coupled to an electrical power source;
a first bridge conductor coupled to the flapper downstream side and configured to selectively close the open circuit formed by the first and second conductors coupled to the flapper stop when the flapper is the full-open position; and
a second bridge conductor coupled to the flapper upstream side and configured to selectively close the open circuit formed by the first and second conductors coupled to the valve body adjacent the flow opening when the flapper is the closed position.

20. A method of indicating the position of a check valve assembly comprising:
providing a valve body having a flow opening;
rotationally mounting a flapper on the valve body, the flapper moveable between a closed position, in which the flapper at least substantially seals the flow channel, and a full-open position, in which the flapper unseals the flow channel;
coupling first and second conductors to the valve body, the first and second conductors spaced apart from each other to form an open circuit, the first and second conductors each adapted to be electrically coupled to an electrical power source; and
coupling a bridge conductor to the flapper, the bridge conductor configured to selectively close the open circuit formed by the first and second conductors when the flapper is in one of the closed or full-open positions;
monitoring the circuit to determine if at least one of the plurality of flappers is in an open or a closed position.
